(19) United States
(12) Patent Application Publication
(10) Pub. No.: US 2019/0382590 A1
(43) Pub. Date: Dec. 19, 2019

(54) ARTICLES SUBJECT TO ICE FORMATION COMPRISING A REPELLENT SURFACE COMPRISING A FLUOROCHEMICAL MATERIAL

(71) Applicant: 3M INNOVATIVE PROPERTIES COMPANY, St. Paul, MN (US)

(72) Inventors: Adam J. Meuler, Woodbury, MN (US); Cheryl L.S. Elsbernd, Woodbury, MN (US)

(21) Appl. No.: 16/081,992

(22) PCT Filed: Apr. 10, 2017
(86) PCT No.: PCT/US2017/026774

§ 371 Date: Sep. 4, 2018

Related U.S. Application Data
(60) Provisional application No. 62/327,792, filed on Apr. 26, 2016.

(51) Int. Cl. C09D 5/00; C09D 167/02; C09D 175/04; C09D 125/06; C08G 63/688

(52) U.S. Cl. CPC C09D 5/00; C09D 167/02; C08G 63/6886; C09D 125/06; C09D 175/04

(57) ABSTRACT

In one embodiment, articles subject to ice formation during normal use are described comprising a repellent surface such that the receding contact angle of the surface with water ranges from 90 degrees to 135 degrees wherein the repellent surface comprises a fluorochemical material having a Mn of at least 1500 g/mole. The fluorochemical material typically has a molecular weight of no greater than 50,000 g/mole. In one embodiment, the repellent surface further comprises a non-fluorinated organic polymeric binder. In another embodiment, the repellent surface comprises a thermally processable polymer and a fluorochemical material melt additive. Also described are methods of making an article comprising providing an article subject to ice formation during normal use; and providing a liquid repellent surface, as described herein, on the article.

### SUMMARY

In one embodiment, articles subject to ice formation during normal use are described comprising a repellent surface such that the receding contact angle of the surface with water ranges from 90 degrees to 135 degrees wherein the repellent surface comprises a fluorochemical material having a Mn of at least 1500 g/mole. The fluorochemical material typically has a molecular weight of no greater than 50,000 g/mole.

In one embodiment, the repellent surface further comprises a non-fluorinated organic polymeric binder. In another embodiment, the repellent surface comprises a thermally processable polymer and a fluorochemical material melt additive.

Also described are methods of making an article comprising providing an article subject to ice formation during normal use; and providing a liquid repellent surface, as described herein, on the article.

### BRIEF DESCRIPTION OF THE DRAWINGS

FIG. 1 is cross-sectional view of an embodied substrate comprising a repellent surface layer.

FIG. 2 is cross-sectional view of another embodiment of an article comprising a repellent surface;

### DETAILED DESCRIPTION

Presently described are articles or components thereof that are subject to ice formation during their normal use. The term “ice” includes any form of frozen water including frost, freezing rain, sleet and snow.

Representative articles include sign faces, signal transmission lines (e.g., telephone and electrical cables), satellite dishes, antennas, wind turbine blades, automobiles, railroad cars, aircraft, watercraft, navigation equipment, heat pumps and exchangers or components thereof, ice manufacturing facilities and articles including ice-cube trays and other “ice maker” components; commercial and residential refrigerators and freezers; cryogenic and supercomputer storage facilities; buildings, transportation signs, roofing, dams (especially near a lock), oil drilling platforms, outdoor sporting equipment; recreational vehicles such as snowmobiles, and snow removal equipment.

A heat exchanger is an article used to transfer heat between one or more fluids. The fluids may be separated by a solid wall to prevent mixing or they may be in direct contact. They are widely used in space heating, refrigeration, air conditioning, power stations, chemical plants, petrochemical plants, petroleum refineries, natural-gas processing, and sewage treatment. The classic example of a heat exchanger is found in an internal combustion engine in which a circulating fluid known as engine coolant flows through radiator coils and air flows past the coils, which cools the coolant and heats the incoming air.

Types of heat exchangers include: shell and tube heat exchanger, plate heat exchangers, plate and shell heat exchanger, adiabatic wheel heat exchanger, plate fin heat exchanger, pillow plate heat exchanger, fluid heat exchanger, waste heat recovery units, dynamic scraped surface heat exchanger, phase-change heat exchangers, direct contact heat exchangers, microchannel heat exchangers.

One of the widest uses of heat exchangers is for air conditioning of buildings and vehicles. This class of heat exchangers is commonly called air coils, or just coils due to their often-serpentine internal tubing. Liquid-to-air, or air-to-liquid HVAC (i.e. heating, ventilation and air conditioning) coils are typically of modified crossflow arrangement. In vehicles, heat coils are often called heater cores.

On the liquid side of these heat exchangers, the common fluids are water, a water-glycol solution, steam, or a refrigerant. For heating coils, hot water and steam are the most common, and this heated fluid is supplied by boilers, for example. For cooling coils, chilled water and refrigerant are most common. Chilled water is supplied from a chiller that is potentially located very far away, but refrigerant must come from a nearby condensing unit. When a refrigerant is used, the cooling coil is the evaporator in the vapor-compression refrigeration cycle. HVAC coils that use this direct-expansion of refrigerants are commonly called DX coils. Some DX coils are “microchannel” type.

On the air side of HVAC coils a significant difference exists between those used for heating, and those for cooling. Air that is cooled often has moisture condensing out of it, except with extremely dry air flows. Heating some air increases that airflow's capacity to hold water. Thus, heating coils need not consider moisture condensation on their air-side. However, cooling coils are designed and selected to handle latent (moisture) as well as the adequate (cooling) loads. The water that is removed is called condensate.

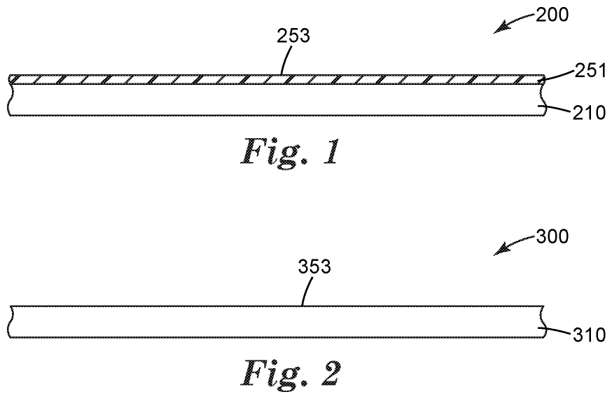

With reference to FIG. 1, article 200 comprises substrate 210 comprising a (e.g. liquid) repellent surface layer (e.g. layer) 251 that comprises a (e.g. non-fluorinated) organic polymeric binder and a fluorochemical material. The concentration of fluorochemical material at the outer exposed surface 253 is typically higher than the concentration of fluorochemical material within the (e.g. non-fluorinated) organic polymeric binder layer 251 proximate substrate 210. The (e.g. liquid) repellent surface layer can be provided by coating substrate 210 with a coating composition comprising an organic solvent, a (e.g. non-fluorinated) organic polymeric binder, and a fluorochemical material; as will subsequently be described.

With reference to FIG. 2, article 300 comprises substrate 310 comprising a (e.g. liquid) repellent surface (e.g. layer) 353 that comprises a fluorochemical material. The concentration of fluorochemical material at the outer exposed surface (e.g. layer) 353 is typically higher than the concentration of fluorochemical material proximate the center of the substrate 310. In one embodiment, the (e.g. liquid) repellent surface 353 can be provided by including a fluorochemical material, such as a fluorochemical compound, as a melt additive in a polymeric material that is thermally processed to form substrate 310 into a component or a surface layer thereof.

The repellent surface repels ice and typically also repels liquids such as water, aqueous solutions and mixtures including paint. The repellent surface also typically repels hydrophobic liquids such as hexadecane.

In some embodiments, the inclusion of the repellent surface can aid in the removal of ice accumulation from the repellent surface. For example, the inclusion of the repellent surface may reduce the force required to remove the ice from the repellent surface. Further, the article may be capable of repeatedly releasing ice from the repellent surface.

In other embodiments, the inclusion of the repellent coating may reduce or prevent ice build-up on the repellent surface. The repellent coating or surface may also reduce the time required to remove ice which has formed on a substrate when the substrate is thawed/defrosted.

The outer exposed surface 253 is preferably (e.g. ice, liquid) repellent such that the advancing and/or receding contact angle of the surface with water is least 90, 95, 100, 105, 110, or 115 degrees. The advancing and/or receding contact angle is typically no greater than 135, 134, 133, 132, 131 or 130 degrees and in some embodiments, no greater than 129, 128, 127, 126, 125, 124, 123, 122, 121, or 120 degrees. The difference between the advancing and/or receding contact angle with water of the (e.g. ice, liquid) repellent surface layer can be at least 5, 10, 15, 20, 25, 30, 35, 40, 45, or 50 degrees. In some embodiments, the difference between the advancing and receding contact angle with water of the surface layer is no greater than 15, 14, 13, 12, 11, 10, 9, 8, 7, 6, 5, 4, 3, 2, or 1 degree. As the difference between the advancing and receding contact angle with water increases, the tilt angle needed to slide or roll off a (e.g. water) droplet from a planar surface increases. One of ordinary skill appreciates that deionized water is utilized when determining contact angles with water.

In some embodiments, the outer exposed surface 253 exhibits a contact angle in the ranges just described after soaking in water for 24 hours at room temperature (25° C.). The contact angle of the (e.g. ice, liquid) repellent surface can also be evaluated with other liquids instead of water such as hexadecane or a solution of 10% by weight 2-n-butoxyethanol and 90% by weight deionized water. In some embodiments, the advancing contact angle with such 2-n-butoxyethanol solution is at least 60, 61, 62, 63, 64, 65, 66, 67, 68, 69, 70 degrees and in some embodiments at least 75 or 80 degrees. In some embodiments, the receding contact angle with such 2-n-butoxyethanol solution is at least 40, 45, 50, 55, 60, 65, or 70 degrees. In some embodiments, the advancing and/or receding contact angle of the (e.g. ice, liquid) repellent surface with such 2-n-butoxyethanol solution is no greater than 100, 95, 90, 85, 80, or 75 degrees.

In another embodiment, the outer exposed surface 253 is preferably (e.g. ice, liquid) repellent such that the receding contact angle of the surface with hexadecane is at least 45, 46, 47, 48, 49, 50, 55, 60, 65, 70, or 75 degrees. The advancing contact angle with hexadecane is typically at least 45, 50, 55, 60, 65, 70, 75, 80, or 84 degrees. In typical embodiments, the receding or advancing contact angle with hexadecane is no greater than 85 or 80 degrees.

The surface layer is not a lubricant impregnated surface. Rather the outer exposed surface is predominantly a solid (e.g. ice, liquid) repellent material. In this embodiment, less than 50, 45, 40, 35, 30, 25, 20, 15, 10, 5, 4, 3, 2, 1, 0.5, 0.1, 0.005, 0.001% of the surface area is a liquid lubricant. Rather, at least 50, 55, 60, 65, 70, 75, 80, 85, 90, 95, 96, 97, 98, 99, 99.5%, or greater of the outer exposed surface is a solid repellent material, as described herein. Thus, a liquid (e.g. water, oil, paint) or solid (e.g. ice) that is being repelled comes in contact with and is repelled by the solid repellent material.

The repellent material is generally a solid at the use temperature of the coated substrate or article, which can be as low as −60° F. or −80° F., yet more typically ranges from −40° F. to 120° F. For outdoor usage in moderate climates, the typical use temperature may be at least −20° F., −10° F., 0° F., or 10° F. In typical embodiments, the repellent material is a solid at room temperature (e.g. 25° C.) and temperatures ranging from 40° F. (4.44° C.) to 130° F. (54.4° C.). In typical embodiments the repellent material has a melting temperature (peak endotherm as measured by DSC) of greater than 25° C. and also typically greater than 130° F. (54.4° C.). In some embodiments, the repellent material has a melting temperature no greater than 200° C. In typical embodiments, a single solid repellent material is utilized. However, the coating composition may contain a mixture of solid repellent materials.

The repellent material has no solubility or only trace solubility with water, e.g., a solubility of 0.01 g/l or 0.001 g/l or less.

The (e.g. liquid, ice) repellent surface layer comprises a fluorochemical material and a (e.g. non-fluorinated) organic polymeric binder. In typical embodiments, a major amount of non-fluorinated polymeric binder is combined with a sufficient amount of fluorochemical material that provides the desired ice and liquid repellency properties, as previously described.

In typical embodiments, the amount of fluorochemical material is at least about 0.005, 0.10, 0.25, 0.5, 1.5, 2.0, or 2.5 wt.-% and in some embodiments, at least about 3.0, 3.5, 4.0, 4.5, or 5 wt.-%. The amount of fluorochemical material is typically no greater than 50, 45, 40, 35, 30, 25, 20, or 15 wt.-% of the sum of the fluorochemical material and (e.g., non-fluorinated) polymeric binder. Thus, the fluorine content of such fluorochemical material-containing polymeric (e.g. binder) materials is significantly less than the fluorine content of fluoropolymers, such as Teflon™ PTFE. The Teflon™ PTFE materials are polytetrafluoroethylene polymers prepared by the polymerization of the monomer tetrafluoroethylene (“TFE” having the structure CF₂═CF₂). It has been found that Teflon™ PTFE does not provide a highly repellent surface such that the receding contact angle with water is at least 90 degrees and/or difference between the advancing contact angle and the receding contact angle of water is less than 10. It is therefore a surprising result that materials containing such low fluorine content can provide comparable or better repellency than fluoropolymers such as Teflon™ PTFE having a substantially higher fluorine content. In some typical embodiments, the fluorochemical material comprises less than 2% of fluorinated groups having greater than 6 carbon atoms. Further, the fluorochemical material typically comprises less than 25% of fluorinated groups having greater than 4 carbon atoms. In favored embodiments, the fluorochemical material is free of fluorinated (e.g. fluoroalkyl) groups, R_{f}, having at least 8 carbon atoms. In some embodiments, the fluorochemical is free of fluorinated (e.g. fluoroalkyl) groups, R_{f}, having at least 5, 6, or 7 carbon atoms. In some embodiments, the repellent surface or repellent coating is free of fluorinated (e.g. fluoroalkyl) groups, R_{f}, having at least 8 carbon atoms. In some embodiments, the repellent surface or repellent coating is free of fluorinated (e.g. fluoroalkyl) groups, R_{f}, having at least 5, 6, or 7 carbon atoms.

In some embodiments, the fluorochemical material comprises an ester compound or oligomer as described in U.S. Pat. No. 6,753,380; incorporated herein by reference. The ester compounds and oligomers may be represented by the following formulas:

R_{f}QO—[C(O)R¹C(O)OR²O]ₙ[C(O)R¹C(O)]m-OQRf (I)

when RfQO— is derived from a fluorinated alcohol, —OR²O— is derived from a fluorinated polyol, and —C(O)R¹C(O)— is derived from a dicarboxylic acid;

R_{f}QC(O)—[OR²OC(O)R¹C(O)]ₙ[OR²O]ₘ—(O)CQR_{f} (II)

when RfQC(O)— is derived from a fluorinated acid, —C(O)R¹C(O)— is derived from a dicarboxylic acid, and —OR²O— is derived from a fluorinated polyol; or
wherein in each of Formulas I-II;
n is a number or a range selected from the numbers 1, 2, 3, 4, 5, 6, 7, 8, 9, or 10;
m is 1;
R_{f} is a fluorinated group;
Q is a divalent linking group;
R¹ is a polyvalent (e.g. divalent) hydrocarbon moiety;
R² is a divalent organic group having a pendent fluorinated group, R_{f}, such as a perfluoroalkyl group, perfluoroheteroalkyl group, or a mixture thereof;

R¹, can be a straight chain, branched chain, or cyclic hydrocarbon, or a combination thereof. Typical R¹ moieties include alkylene, alkene, arylene, and aralkylene having 4-50 carbon atoms. In some embodiments, R¹ is preferably a saturated hydrocarbon moiety or in other words an alkylene group (i.e. when n is 2 or 3) or alkyl group (i.e. when n is 1) averaging at least 4, 6, 8, 10, 12, 14, 16, or 18 carbon atoms. In some embodiments, the alkylene or alkyl group averages no greater than 45, 40, 35, 30, 25, or 20 carbon atoms. In typical embodiments, R¹ is a hydrocarbon portion of a dicarboxylic acid or diol. In another embodiment, the hydrocarbon moiety may further comprise one or more heteroatoms or other substituents.

It will be understood that mixtures of compounds and oligomers corresponding to the general formula may be represented, in addition to single compounds. In the case of mixtures, m and n may average a non-integral value. The mixture of compounds and oligomers may comprise a small concentration (e.g. less than 5, 4, 3, 2, or 1 wt.-% of the compound or oligomer) of other compounds and oligomers. For example, the mixture may comprise species wherein m is 0 and the terminal oxygen atom of unit n is bonded to a hydrogen such that the unit terminates with a hydroxyl group or acid group.

The fluorinated group, R_{f}, is typically a fluoroalkyl group that contains at least 3 or 4 carbon atoms and typically no greater than 12, 8, or 6 carbon atoms. The fluoroalkyl group can be straight chain, branched chain, cyclic or combinations thereof. In typical embodiments, the fluoroalkyl group is preferably free of olefinic unsaturation. In some embodiments, each terminal fluorinated group contains at least 50, 55, 60, 65, or 70% to 78% fluorine by weight. Such terminal groups are typically perfluorinated. In some embodiments, R_{f} is CF₃(CF₂)₃— or in other words C₄F₉— for at least 50%, 55%, 60%, 65%, 70%, 75%, 80%, 85%, 90%, or 95% by weight or greater of the mixture of compounds. In other embodiments, the fluorinated material can be a single compound wherein R_{f} is CF₃(CF₂)₃— or in otherwords a C4 perfluoroalkyl group. In another embodiment, the fluorinated group, R_{f}, is a perfluoroheteroalkyl group, such as a perfluoroether or perfluoropolyether.

Q is typically the organic divalent linking group, L. L can be a covalent bond, a heteroatom (e.g., O or S), or an organic moiety. The organic divalent linking group typically contains no greater than 20 carbon atoms, and optionally contains oxygen-, nitrogen-, or sulfur-containing groups or a combination thereof. L is typically free of active hydrogen atoms. Examples of L moieties include straight chain, branched chain, or cyclic alkylene, arylene, aralkylene, oxy, thio, sulfonyl, amide, and combinations thereof such as sulfonamidoalkylene. Below is a representative list of suitable organic divalent linking groups.

—SO₂N(R¹)(CH₂)ₖ—

—CON(R¹)(CH₂)ₖ—

—(CH₂)ₖ—

—(CH₂)ₖO(CH₂)ₖ—

—(CH₂)ₖS(CH₂)ₖ—

—(CH₂)ₖSO₂(CH₂)ₖ—

—(CH₂)ₖOC(O)NH—

—(CH₂)SO₂N(R¹)(CH₂)ₖ—

—(CH₂)ₖNR¹—

—(CH₂)ₖNR¹C(O)NH—

For the purpose of this list, each k is independently an integer from 1 to 12. R¹ is hydrogen, phenyl, or an alkyl of 1 to about 4 carbon atoms (and is preferably methyl). In some embodiments, k is no greater than 6, 5, 4, 3, or 2. In some embodiments, the linking group has a molecular weight of at least 14 g/mole, in the case of —CH₂—, or at least 20, 25, 30, 40, 50, 60, 70, 80, 90, 100, or 110 g/mole. The molecular weight of the linking group is typically no greater than 350 g/mole and in some embodiments no greater than 300, 250, 200, or 150 g/mole.

As depicted in Formula I, R¹ is typically a residue of a polyacyl compound; whereas R² is typically a residue of a polyol. In this embodiment, the fluorochemical ester oligomer typically comprises the condensation reaction products of one or more fluorinated polyols (such as FBSEE—C₄F₉SO₂N(C₂H₄OH)₂), one or more polyacyl compounds (e.g. dicarboxylic acid) and one or more monofunctional fluorine-containing compounds (such as MeFBSE—C₄F₉SO₂N(CH₃)CH₂CH₂OH).

One representative compound according to Formula I is depicted as follows:

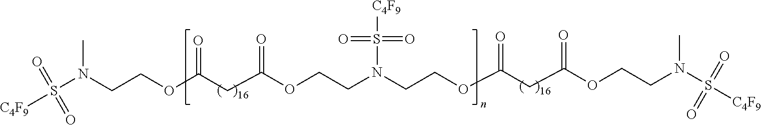

wherein n ranges from 1 to 10.

Other representative compounds are described in U.S. Pat. No. 6,753,380.

Polyols, suitable for use in preparing the fluorochemical ester compositions include polyols that have an average hydroxyl functionality of greater than 1 (preferably about 2 to 3; most preferably, about 2, as diols are most preferred). The hydroxyl groups can be primary or secondary, with primary hydroxyl groups being preferred for their greater reactivity.

Representative examples of suitable fluorinated polyols include R_{f}SO₂N(CH₂CH₂OH)₂ such as N-bis(2-hydroxyethyl)perfluorobutylsulfonamide; R_{f}OC₆H₄SO₂N(CH₂CH₂OH)₂; R_{f}SO₂N(R¹)CH₂CH(OH)CH₂OH such as C₆F₁₃SO₂N(C₃H₇)CH₂CH(OH)CH₂OH; R_{f}CH₂CON(CH₂CH₂OH)₂; R_{f}CON(CH₂CH₂OH)₂; CF₃CF₂(OCF₂CF₂)₃OCF₂CON(CH₃)CH₂CH(OH)CH₂OH; R_{f}OCH₂CH(OH)CH₂OH such as C₄F₉OCH₂CH(OH)CH₂OH; R_{f}CH₂CH₂SC₃H₆OCH₂CH(OH)CH₂OH; R_{f}CH₂CH₂SC₃H₆CH(CH₂OH)₂; R_{f}CH₂CH₂SCH₂CH(OH)CH₂OH; R_{f}CH₂CH₂SCH(CH₂OH)CH₂CH₂OH; R_{f}CH₂CH₂CH₂SCH₂CH(OH)CH₂OH such as C₅F₁₁(CH₂)₃SCH₂CH(OH)CH₂OH; R_{f}CH₂CH₂CH₂OCH₂CH(OH)CH₂OH such as C₅F₁₁(CH₂)₃OCH₂CH(OH)CH₂OH; R_{f}CH₂CH₂CH₂OC₂H₄OCH₂CH(OH)CH₂OH; R_{f}CH₂CH₂(CH₃)OCH₂CH(OH)CH₂OH; R_{f}(CH₂)₄SC₃H₆CH(CH₂OH)CH₂OH; R_{f}(CH₂)₄SCH₂CH(CH₂OH)₂; R_{f}(CH₂)₄SC₃H₆OCH₂CH(OH)CH₂OH; R_{f}CH₂CH(C₄H₉)SCH₂CH(OH)CH₂OH; R_{f}CH₂OCH₂CH(OH)CH₂OH; R_{f}CH₂CH(OH)CH₂SCH₂CH₂OH; R_{f}CH₂CH(OH)CH₂SCH₂CH₂OH; R_{f}CH₂CH(OH)CH₂OCH₂CH₂OH; R_{f}CH₂CH(OH)CH₂OH; ((CF₃)₂CFO(CF₂)₂(CH₂)₂SCH₂)₂C(CH₂OH)₂; 1,4-bis(1-hydroxy-1,1-dihydroperfluoroethoxyethoxy)perfluoro-n-butane (HOCH₂CF₂OC₂F₄O(CF₂)₄OC₂F₄OCF₂CH₂OH); 1,4-bis(1-hydroxy-1,1-dihydroperfluoropropoxy)perfluoro-n-butane (HOCH₂CF₂CF₂O(CF₂)₄OCF₂CF₂CH₂OH); fluorinated oxetane polyols made by the ring-opening polymerization of fluorinated oxetane such as Poly-3-Fox™ (available from Omnova Solutions, Inc., Akron Ohio); polyetheralcohols prepared by ring opening addition polymerization of a fluorinated organic group substituted epoxide with a compound containing at least two hydroxyl groups as described in U.S. Pat. No. 4,508,916 (Newell et al); and perfluoropolyether diols such as Fomblin™ ZDOL (HOCH₂CF₂O(CF₂O)₈₋₁₂ (CF₂CF₂O)₈₋₁₂ CF₂CH₂OH, available from Ausimont); wherein R_{f} is a fluorinated group such as a perfluoroalkyl group as previously described.

Preferred fluorinated polyols include N-bis(2-hydroxyethyl) perfluorobutylsulfonamide; fluorinated oxetane polyols made by the ring-opening polymerization of fluorinated oxetane such as Poly-3-Fox™ (available from Omnova Solutions, Inc., Akron Ohio); polyetheralcohols prepared by ring opening addition polymerization of a fluorinated organic group substituted epoxide with a compound containing at least two hydroxyl groups as described in U.S. Pat. No. 4,508,916 (Newell et al); perfluoropolyether diols such as Fomblin™ ZDOL (HOCH₂CF₂O(CF₂O)₈₋₁₂ (CF₂CF₂O)₈₋₁₂CF₂CH₂OH, available from Ausimont); 1,4-bis(1-hydroxy-1,1-dihydroperfluoroethoxyethoxy)perfluoro-n-butane (HOCH₂CF₂OC₂F₄O(CF₂)₄OC₂F₄OCF₂CH₂OH); and 1,4-bis(1-hydroxy-1,1-dihydroperfluoropropoxy)perfluoro-n-butane (HOCH₂CF₂CF₂O(CF₂)₄OCF₂CF₂CH₂OH).

More preferred polyols comprised of at least one fluorine-containing group include N-bis(2-hydroxyethyl)perfluorobutylsulfonamide; 1,4-bis(1-hydroxy-1,1-dihydroperfluoropropoxy)perfluoro-n-butane (HOCH₂CF₂CF₂O(CF₂)₄OCF₂CF₂CH₂OH).

Suitable non-fluorinated polyols include those that comprise at least one aliphatic, heteroaliphatic, alicyclic, heteroalicyclic, aromatic, heteroaromatic, or polymeric moiety.

Non-fluorinated polyols include for example alkylene glycols such as 1,2-ethanediol; 1,2-propanediol; 3-chloro-1,2-propanediol; 1,3-propanediol; 1,3-butanediol; 1,4-butanediol; 2-methyl-1,3-propanediol; 2,2-dimethyl-1,3-propanediol (neopentylglycol); 2-ethyl-1,3-propanediol; 2,2-diethyl-1,3-propanediol; 1,5-pentanediol; 2-ethyl-1,3-pentanediol; 2,2,4-trimethyl-1,3-pentanediol; 3-methyl-1,5-pentanediol; 1,2-, 1,5-, and 1,6-hexanediol; 2-ethyl-1,6-hexanediol; bis(hydroxymethyl)cyclohexane; 1,8-octanediol; bicyclo-octanediol; 1,10-decanediol; tricyclo-decanediol; norbornanediol; and 1,18-dihydroxyoctadecane.

R¹ is typically a residue of a polyacyl compound(s). The polyacryl compound is typically a carboxylic acid, or a derivative thereof. Suitable dicarboxylic acids include adipic acid, suberic acid, azelaic acid, dodecanedioic acid, octadecanedioic acid, eicosanedioic acid, and the like that provide the R¹ group as previously described.

Useful fluorine-containing monofunctional compounds include compounds of the following formula:

R_{f}-Q′ (III)

wherein:
R_{f} is a fluorinated group, preferably a fluoroalkyl or (e.g. C4) perfluoroalkyl group as previously described; and
Q′ is a moiety comprising a functional group that is reactive toward the terminal acyl (of the polyacyl compound) or hydroxyl groups (of the polyol).

It will be understood that the compound RfQ′ reacts with the polyol or acyl compounds to provide the terminal moiety R_{f}Q-

R_{f}Q′ typically comprises fluorine-containing monoalcohols. Representative examples of useful fluorine-containing monoalcohols include the following wherein R_{f} is a fluorinated group as previously described.

| | |
|---|---|
| R_{f}SO₂N(CH₃)CH₂CH₂OH, | CF₃(CF₂)₃SO₂N(CH₃)CH₂CH₂OH, |
| CF₃(CF₂)₃SO₂N(CH₃)CH(CH₃)CH₂OH, | CF₃(CF₂)₃SO₂N(CH₃)CH₂CH(CH₃)OH, |
| C₃F₇CH₂OH, | R_{f}SO₂N(H)(CH₂)₂OH, |
| R_{f}SO₂N(CH₃)(CH₂)₄OH, | C₄F₉SO₂N(CH₃)(CH₂)₄OH |
| C₆F₁₃SO₂N(CH₃)(CH₂)₄OH, | R_{f}SO₂N(CH₃)(CH₂)₁₁OH, |
| R_{f}SO₂N(C₂H₅)CH₂CH₂OH, | CF₃(CF₂)₃SO₂N(C₂H₅)CH₂CH₂OH, |
| C₆F₁₃SO₂N(C₂H₅)CH₂CH₂OH | R_{f}SO₂N(C₂H₅)(CH₂)₆OH, |
| C₃F₇CONHCH₂CH₂OH, | R_{f}SO₂N(C₃H₇)CH₂OCH₂CH₂CH₂OH, |
| R_{f}SO₂N(CH₂CH₂CH₃)CH₂CH₂OH, | R_{f}SO₂N(C₄H₉)(CH₂)₄OH, |
| R_{f}SO₂N(C₄H₉)CH₂CH₂OH, | |

Various fluorine-containing monoalcohols are also described in previously cited U.S. Pat. No. 6,753,380.

The fluorochemical monofunctional compound RfQ′ may comprise a fluorine-containing monocarboxylic acids, or derivative thereof. Various fluorine-containing monocarboxylic acids are described in previously cited U.S. Pat. No. 6,753,380.

If desired, (e.g. a small concentration of) non-fluorinated monofunctional compounds, such as monoalcohol(s) or monocarboxylic acid(s) can be utilized.

In another embodiment, the fluorochemical material comprises a urethane compound or oligomer as described in U.S. Pat. No. 6,803,109. The urethane compounds and oligomers may be represented by the following formula:

R_{f}QO—C(O)NHR¹NHC(O)—OQRf (IV)

when R_{f}QO— is derived from a fluorinated alcohol and —C(O)NHR¹NHC(O)— is derived from a diisocyanate; or

R_{f}QO—[C(O)NHR¹NHC(O)OR²O]ₙ[C(O)NHR¹NHC(O)]m-OQRf (V)

when R_{f}QO— is derived from a fluorinated alcohol, —OR²O— is derived from a fluorinated polyol, and —C(O)NHR¹NHC(O)— is derived from a diisocyanate;
wherein in Formulas IV and V:
n is a number or a range selected from the numbers 1, 2, 3, 4, 5, 6, 7, 8, 9, or 10;
m is 1;
R_{f} is a fluorinated group, as previously described;
Q is a divalent linking group, as previously described; and
R¹ and R² are as previously described.

It will be understood that mixtures of compounds and oligomers corresponding to the general formula may be represented, in addition to single compounds. In the case of mixtures, m and n may average a non-integral value. The mixture of compounds and oligomers may comprise a small concentration (e.g. less than 5, 4, 3, 2, or 1 wt.-% of the compound or oligomer) of other compounds and oligomers. For example, the mixture may comprise species wherein m is 0 and the terminal oxygen atom of unit n is bonded to a hydrogen such that the unit terminates with a hydroxyl group.

Representative compounds are described in U.S. Pat. No. 6,803,109; incorporated herein by reference.

As depicted in Formula V, the fluorochemical urethane oligomer typically comprises the condensation reaction products of one or more fluorinated polyols (such as FBSEE—C₄F₉SO₂N(C₂H₄OH)₂, one or more polyisocyanate compounds, and one or more monofunctional fluorine-containing compounds (such as MeFBSE—C₄F₉SO₂N(CH₃)CH₂CH₂OH)).

In another embodiment, a fluorine-containing polyol can be chain extended with a diisocyanate which is then reacted with a polyol comprising R¹. In this embodiment, the oligomer would have the following formula:

R_{f}QO—[C(O)NHZR²ZNHC(O)OR¹O]ₙ[C(O)NHZR²ZNHC(O)]m-OQRf (VI)

wherein Rf, R¹, and R² are the same as previously described; —C(O)NHZR²ZNHC(O)— is a residue of the chain extended fluorine-containing polyol and Z is a residue of a diisocyanate, such as a C4-C6 hydrocarbon (e.g. alkylene).

Useful fluorinated polyols for the preparation of the urethane compounds and oligomers are the same as previously described.

Various polyisocyanate compounds are useful in preparing the urethane compounds and oligomers. The polyisocyanate compounds generally comprise isocyanate radicals attached to a multivalent organic group that can comprise a multivalent aliphatic, alicyclic, or aromatic moiety (R¹); or a multivalent aliphatic, alicyclic or aromatic moiety attached to a biuret, an isocyanurate, or a uretdione, or mixtures thereof. Preferred polyfunctional isocyanate compounds contain an average of two isocyanate (—NCO) radicals. Compounds containing two —NCO radicals are preferably comprised of divalent aliphatic, alicyclic, araliphatic, or aromatic groups to which the —NCO radicals are attached. Linear aliphatic divalent groups are preferred.

Representative examples of suitable polyisocyanate compounds include isocyanate functional derivatives. Examples of derivatives include, for example, ureas, biurets, allophanates, dimers and trimers (such as uretdiones and isocyanurates) of isocyanate compounds, and mixtures thereof. Any suitable organic polyisocyanate, such as an aliphatic, alicyclic, araliphatic, or aromatic polyisocyanate, may be used either singly or in mixtures of two or more. The aliphatic polyisocyanate compounds generally provide better light stability than the aromatic compounds. Aromatic polyisocyanate compounds, on the other hand, are generally more economical and reactive toward polyols than are aliphatic polyisocyanate compounds.

Suitable aromatic polyisocyanate compounds include, for example, 2,4-toluene diisocyanate (TDI), 2,6-toluene diisocyanate, an adduct of TDI with trimethylolpropane (available as Desmodur™ CB from Bayer Corporation, Pittsburgh, Pa.), the isocyanurate trimer of TDI (available as Desmodur™ IL from Bayer Corporation, Pittsburgh, Pa.), diphenylmethane 4,4′-diisocyanate (MDI), diphenylmethane 2,4′-diisocyanate, 1,5-diisocyanato-naphthalene, 1,4-phenylene diisocyanate, 1,3-phenylene diisocyanate, 1-methyoxy-2,4-phenylene diisocyanate, 1-chlorophenyl-2,4-diisocyanate, and mixtures thereof.

Examples of useful alicyclic polyisocyanate compounds include, for example, dicyclohexylmethane diisocyanate (H₁₂MDI, commercially available as DesmodurTMW, available from Bayer Corporation, Pittsburgh, Pa.), 4,4′-isopropyl-bis(cyclohexylisocyanate), isophorone diisocyanate (IPDI), cyclobutane-1,3-diisocyanate, cyclohexane 1,3-diisocyanate, cyclohexane 1,4-diisocyanate (CHDI), 1,4-cyclohexanebis(methylene isocyanate) (BDI), dimmer acid diisocyanate (available from Bayer),1,3-bis(isocyanatomethyl)cyclohexane (H₆XDI), 3-isocyanatomethyl-3,5,5-trimethylcyclohexyl isocyanate, and mixtures thereof.

Examples of useful aliphatic polyfunctional isocyanate compounds include, for example, tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, 2,2,4-trimethyl-hexamethylene diisocyanate (TMDI), 2-methyl-1,5-pentamethylene diisocyanate, dimer diisocyanate, the urea of hexamethylene diisocyanate, the biuret of hexamethylene 1,6-diisocyanate (HDI) (Desmodur N-100 and N-3200 from Bayer Corporation, Pittsburgh, Pa.), the isocyanurate of HDI (available as Desmodur™ N-3300 and Desmodur™ N-3600 from Bayer Corporation, Pittsburgh, Pa.), a blend of the isocyanurate of HDI and the uretdione of HDI (available as Desmodure™ N-3400 available from Bayer Corporation, Pittsburgh, Pa.), and mixtures thereof.

Examples of useful araliphatic polyisocyanates include, for example. m-tetramethyl xylylene diisocyanate (m-TMXDI), p-tetramethyl xylylene diisocyanate (p-TMXDI), 1,4-xylylene diisocyanate (XDI), 1,3-xylylene diisocyanate, p-(1-isocyanatoethyl)phenyl isocyanate, m-(3-isocyanatobutyl)phenyl isocyanate, 4-(2-isocyanatocyclohexyl-methyl)phenyl isocyanate, and mixtures thereof.

Preferred polyisocyanates, in general, include alkylene diisocyanates such as tetramethylene 1,4-diisocyanate, hexamethylene 1,4-diisocyanate, hexamethylene 1,6-diisocyanate (HDI), octamethylene 1,8-diisocyanate, 1,12-diisocyanatododecane, and the like, and mixtures thereof.

Useful fluorochemical monofunctional compounds include those of the following formula:

R_{f}-Q″ (VII)

wherein:
R_{f} is a fluorinated group, preferably a fluoroalkyl of (e.g. C4) perfluoroalkyl group, as previously described; and
Q″ is a moiety comprising a functional group that is reactive toward the terminal isocyanate or hydroxy groups.

It will be understood that the compound RfQ″ reacts to provide the terminal moiety RfQ-. Examples of useful reactive functional group Q″ are described in previously cited U.S. Pat. No. 6,803,109.

R_{f}Q″ typically comprises a fluorine-containing monoalcohol as previously described. Various fluorine-containing monoalcohols are also described in previously cited U.S. Pat. No. 6,803,109.

If desired, (e.g. a small concentration of) non-fluorinated monofunctional compounds, such as monoalcohol(s) can be utilized.

The fluorochemical materials of Formulas I, II, and V can be characterized as fluorinated oligomers or polymers comprising terminal fluorinated (e.g. C4 perfluoroalkyl) groups and pendent fluorinated (e.g. C4 perfluoroalkyl) groups. The fluorochemical materials of Formulas I, II, IV, and V can be characterized as comprising a hydrocarbon (e.g. alkylene) group(s) averaging at least 8, 10, 12, 14, 16, 18, or 20 carbon atoms.

The fluorinated oligomers may have a molecular weight (Mn) of at least 1500 or 2000 g/mole. The fluorinated oligomer typically has a molecular weight (Mn) no greater than 10,000, 9000, 8000, or 7000 g/mole. The fluorinated polymer typically has a molecular weight (Mn) greater than 10,000; 15,000; or 20,000 g/mole. In some embodiments, the molecular weight of the fluorinated polymer is no greater than 50,000; 40,000 or 30,000 g/mole. The molecular weight can be determined by Gel Permeation Chromatography using polystyrene standards.

In some embodiments, the fluorochemical material further comprises a compound or a mixture of compounds represented by the formula:

(R_{f}-L-P)ₙA (VIII)

R_{f} is a fluorinated group as previously described;
L is independently an organic divalent linking group as previously described;
P is independently a catenary, divalent heteroatom-containing a carbonyl moiety;
A is hydrocarbon moiety;
and n typically ranges from 1 to 3.

In some embodiments, n is preferably 2. When the fluorochemical material comprises a mixture of compounds, the concentration by weight of the fluorochemical compound wherein n is 2 is typically greater than each of the fractions wherein n is not 2 (e.g. n=1 or n=3). Further, the concentration wherein n is 2 is typically at least 50%, 55%, 60%, 65%, 70%, 75%, 80%, 85%, 90%, or 95% by weight or greater of the mixture of compounds.

The aforementioned moiety, A, can be a straight chain, branched chain, or cyclic hydrocarbon, or a combination thereof. Typical A moieties include alkylene, alkene, arylene, and aralkylene having 4-50 carbon atoms. In some embodiments, A is preferably a saturated hydrocarbon moiety or in other words an alkylene group (i.e. when n is 2 or 3) or alkyl group (i.e. when n is 1) averaging at least 4, 6, 8, 10, 12, 14, 16, or 18 carbon atoms. In some embodiments, the alkylene or alkyl group averages no greater than 45, 40, 35, 30, 25, or 20 carbon atoms. In typical embodiments, A is a hydrocarbon portion of a dicarboxylic acid or fatty acid.

The divalent carbonyl moiety, P, is typically a residue of a dicarboxylic or fatty acid and thus carbonyloxy (—C(O)O—) or in other words an ester group.

The fluorochemical compound can be prepared by various methods known in the art such as described in U.S. Pat. No. 6,171,983. The fluorochemical is most typically prepared by esterifying a fluorinated alcohol with a dicarboxylic acid or a fatty acid. Particularly when a fatty acid is utilized as a starting material the resulting fluorochemical material typically contains a mixture of compounds.

Suitable dicarboxylic acids include adipic acid, suberic acid, azelaic acid, dodecanedioic acid, octadecanedioic acid, eicosanedioic acid, and the like that provide the A group as previously described. Derivatives of dicarboxylic acid can also be employed such as halides and anhydrides.

Suitable unsaturated fatty acids include for example-palmitoleic acid, linoleic acid, linolenic acid, oleic acid, rinoleic acid, gadoleic acid, eracic acid or mixtures thereof. Polymerized fatty acids can contain a higher number of carbon atoms such that the fluorochemical compound averages 30, 35, 40, 45 or 50 carbon atoms.

Suitable saturated fatty acids include caprylic acid, CH₃(CH₂)₆COOH; capric acid, CH₃(CH₂)₈COOH; lauric acid, CH₃(CH₂)₁₀COOH; myristic acid, CH₃(CH₂)₁₂COOH; palmitic CH₃(CH₂)₁₄COOH; stearic acid CH₃(CH₂)₁₆COOH; arachidic acid, CH₃(CH₂)₁₈COOH; behenic acid CH₃(CH₂)₂₀COOH; lignoceric acid, CH₃(CH₂)₂₂COOH; and cerotic acid CH₃(CH₂)₂₄.COOH.

Representative examples of useful fluorine-containing monoalcohols are the same as previously described.

Other fluorine-containing monoalcohols are described in U.S. Pat. No. 6,586,522; incorporated herein by reference.

In some embodiments, the monofunctional fluoroaliphatic alcohols useful in preparing the fluorochemical compounds include the N-alkanol perfluoroalkylsulfonamides described in U.S. Pat. No. 2,803,656 (Ahlbrecht et al.), which have the general formula R_{f} SO₂N(R)R₁CH₂OH wherein R_{f} is a perfluoroalkyl group having 3 to 6 and preferably 4 carbon atoms, R₁ is an alkylene radical having 1 to 12 carbon atoms, and R is a hydrogen atom or an alkyl group containing 1 to 4 carbon atoms and is preferably methyl. In some embodiments, R₁ is an alkylene radical having no greater than 8, 7, 6, 5, 4, 3, or 2 carbon atoms. These monofunctional alcohols can be prepared by reactions of an acetate ester of halohydrin with a sodium or potassium salt of the corresponding perfluoroalkylsulfonamide.

In some embodiments, the fluorochemical compound has the following formulas

C₄F₉SO₂N(CH₃)(CH₂)ₖOC(O)-A-C(O)O(CH₂)ₖN(CH₃)SO₂C₄F₉ (IX)

or

C₄F₉SO₂N(CH₃)(CH₂)ₖOC(O)-A (X)

wherein k and A are the same as previously described.

In some embodiments, the repellent surface or coating comprises both a fluorochemical compound (e.g. of Formulas IV or VIII-X) and a fluorochemical oligomer (e.g. of Formulas I, II, V, and VI. The weight ratio of fluorochemical compound to fluorochemical oligomer can range from 1:10 to 10:1. In some embodiments, the weight ratio ranges from 1:4 to 4:1. In other embodiments, the weight ratio ranges from 1:3 to 3:1. In other embodiments, the weight ratio ranges from 1:2 to 2:1.

Fluorochemical compounds according to the formulas described herein are not fluoroalkyl silsesquioxane materials having the chemical formula [RSiO_{3/2}]ₙ, wherein R comprises a fluoroalkyl or other fluorinated organic group. Fluorochemical compounds according to the formulas described herein are also not (e.g. vinyl terminated) polydimethylsiloxanes. In typical embodiments, the fluorochemical material is free of silicon atoms as well as siloxane linkages.

In some embodiments, the (e.g. starting materials of the fluorochemical compound are selected such that the) fluorochemical compound has a molecular weight (Mw) no greater than 1500, 1400, 1300, 1200, 1100, or 1000 g/mole. In some embodiments the molecular weight is at least 250, 300, 350, 400, 450, 500, 550, 600, or 700 g/mole.

In some embodiments, the (e.g. starting materials of the fluorochemical compound are selected such that the) fluorochemical material (e.g. oligomer or compound) has a fluorine content of at least 25 wt.-%. In some embodiments, the fluorine content of the fluorochemical material is at least 26, 27, 28, 29, 30, 31, 32, 33, or 34 wt.-% and typically no greater than 58, 57, 56, 55, 54, 53, 52, 51, or 50 wt.-%.

Various organic polymeric binders can be utilized. Although fluorinated organic polymeric binders can also be utilized, fluorinated organic polymeric binders are typically considerably more expensive than non-fluorinated binders. Further, non-fluorinated organic polymeric binders can exhibit better adhesion to non-fluorinated polymeric, metal, or other substrates.

Suitable non-fluorinated binders include for example polystyrene, atactic polystyrene, acrylic (i.e. poly(meth)acrylate), polyester, polyurethane (including polyester type thermoplastic polyurethanes “TPU”), polyolefin (e.g. polyethylene), and polyvinyl chloride. Many of the polymeric materials that a substrate can be thermally processed from, as will subsequently be described, can be used as the non-fluorinated organic polymeric binder of the organic solvent coating composition. However, in typical embodiments, the non-fluorinated organic polymeric binder is a different material than the polymeric material of the substrate. In some embodiments, the organic polymeric binder typically has a receding contact angle with water of less than 90, 80, or 70 degrees. Thus, the binder is typically not a silicone material.

In some embodiments, the (e.g. non-fluorinated) organic polymeric binder is a film-grade resin, having a relatively high molecular weight. Film-grade resins can be more durable and less soluble in the liquid/solid (e.g. water, oil, paint, ice) being repelled. In other embodiments, the (e.g. non-fluorinated) organic polymeric binder can be a lower molecular weight film-forming resin. Film-forming resins can be more compliant and less likely to affect the mechanical properties of the substrate. Viscosity and melt flow index are indicative of the molecular weight. Mixtures of (e.g. non-fluorinated) organic polymeric binders can also be used.

In some embodiments, the film-grade (e.g. non-fluorinated) organic polymeric binder typically has a melt flow index of at least 1, 1.5, 2, 2.5, 3, 4, or 5 g/10 min at 200° C./5 kg ranging up to 20, 25, or 30 g/10 min at 200° C./5 kg. The melt flow index can be determined according to ASTM D-1238. The tensile strength of the (e.g. non-fluorinated) organic polymeric binder is typically at least 40, 45, 50, 55, or 60 MPa. Further, the (e.g. non-fluorinated) organic polymeric binder can have a low elongation at break of less than 10% or 5%. The tensile and elongation properties can be measured according to ASTM D-638.

In other embodiments, the (e.g. non-fluorinated) organic polymeric binders have a lower molecular weight and lower tensile strength than film-grade polymers. In one embodiment, the melt viscosity of the (e.g. non-fluorinated) organic polymeric binders (as measured by ASTM D-1084-88) at 400° F. (204° C.) ranges from about 50,000 to 100,000 cps. In another embodiment, the molecular weight (Mw) of the (e.g. non-fluorinated) organic polymeric binder is typically at least about 1000, 2000, 3000, 4000, or 5000 g/mole ranging up to 10,000; 25,000; 50,000; 75,000; 100,000; 200,000; 300,000; 400,000, or 500,000 g/mole. In some embodiments, the (e.g. non-fluorinated) organic polymeric binder has a tensile strength of at least 5, 10, or 15 MPa ranging up to 25, 30, or 35 MPa. In other embodiments, the (e.g. non-fluorinated) organic polymeric binder has a tensile strength of at least 40, 45, or 50 MPa ranging up to 75 or 100 MPa. In some embodiments, the (e.g. non-fluorinated) organic polymeric binder has an elongation at break ranging up to 25, 50, 100, 200, 300, 400, 500, 600, 700, 800, 900, 1000% or higher. In some embodiments, the (e.g. non-fluorinated) organic polymeric binder has a Shore A hardness of at least 50, 60, 70, or 80 ranging up to 100.

In some embodiments, the (e.g. non-fluorinated) organic polymeric binder is selected such that it is compliant at the use temperature of the coated substrate or article.

In this embodiment, the (e.g. non-fluorinated) organic polymeric binder has a glass transition temperature (Tg) as can be measured by DSC of less than 0° C. or 32° F. In some embodiments, the (e.g. non-fluorinated) organic polymeric binder has a glass transition temperature (Tg) of less than 20° F., 10° F., 0° F., −10° F., −20° F., −30° F., −40° F., −50° F., −60° F., −70° F., or −80° F. The (Tg) of many (e.g. non-fluorinated) organic polymeric binder is at least −130° C.

The selection of (e.g. non-fluorinated) organic polymeric binder contributes to the durability of the repellent surface. In some embodiments, the repellency is retained after surface abrasion testing (according to the test method described in the examples). In some embodiments, the liquid (e.g. paint) repellency may diminish to some extent, yet remains highly repellent after surface abrasion testing. Thus, after surface abrasion testing the contact angles or ice adhesion meets the criteria previously described. In other embodiments, the repellency is retained after soaking the repellent surface in water (according to the test method described in the examples). In yet other embodiments, the repellency is retained after repeatedly forming and removing ice from the liquid repellent surface.

In typical embodiments, the non-fluorinated organic polymeric binder does not form a chemical (e.g. covalent) bond with the fluorochemical material as this may hinder the migration of the fluorochemical material to the outermost surface layer.

In some embodiments, the (e.g. non-fluorinated) organic polymeric binder is not curable, such as in the case of alkyd resins. An alkyd resin is a polyester modified by the addition of fatty acids and other components, derived from polyols and a dicarboxylic acid or carboxylic acid anhydride. Alkyds are the most common resin or “binder” of most commercial “oil-based” paints and coatings.

In some embodiments, the selection of the non-fluorinated polymeric binder can affect the concentration of fluorochemical material that provides the desired (e.g. liquid, ice) repellency properties. For example when the binder is atactic polystyrene, having a molecular weight of 800-5000 kg/mole, or polystyrene available under the trade designation “Styron 685D”, the concentration of fluorochemical material was found to exceed 2.5 wt.-% in order to obtain the desired repellency properties. Thus, for some non-fluorinated polymeric binders, the concentration of fluorochemical material may be at least 3, 3.5, 4, or 5 wt.-% of the total amount of fluorochemical material and (e.g. non-fluorinated) polymeric binder.

Further, when the binder is PMMA, i.e. polymethylmethacrylate, (available from Alfa Aesar) 50 wt.-% of fluorochemical material resulted in a receding contact angle with water of 86 degrees. However, lower concentrations of fluorochemical material resulted in a receding contact angle with water of greater than 90 degrees. Thus, for some non-fluorinated polymeric binders, the concentration of fluorochemical material may be less than 50 wt.-% of the total amount of fluorochemical material and (e.g. non-fluorinated) polymeric binder.

The compositions comprising a fluorochemical material and a (e.g., non-fluorinated organic) polymeric binder can be dissolved, suspended, or dispersed in a variety of organic solvents to form a coating composition suitable for use in coating the compositions onto a substrate. The organic solvent coating compositions typically contain at least about 70%, 80%, 90%, 91%, 92%, 93%, 94%, 95%, 96%, 97%, 98%, 99% organic solvent or greater, based on the total weight of the coating composition. The coating compositions typically contain at least about 0.01%, 0.1%, 0.5%, 1%, 2%, 3%, 4%, 5%, 6%, 7%, 8%, 9%, 10%, 15% or greater solids of the (e.g. non-fluorinated organic) polymeric binder and fluorochemical material, based on the total weight of the coating composition. However, the coating composition can be provided with an even higher amount of solids, e.g. 20, 30, 40, or 50 wt.-% solids. Suitable organic solvents include for example alcohols, esters, glycol ethers, amides, ketones, hydrocarbons, chlorohydrocarbons, hydrofluorocarbons, hydrofluoroethers, chlorocarbons, and mixtures thereof.

The coating composition may contain one or more additives provided the inclusion of such does not detract from the (e.g. liquid, ice) repellent properties.

The coating compositions can be applied to a substrate or article by standard methods such as, for example, spraying, padding, dipping, roll coating, brushing, or exhaustion (optionally followed by the drying of the treated substrate to remove any remaining water or organic solvent). The substrate can be in the form of sheet articles that can be subsequently thermally formed into a substrate or component. When coating flat substrates of appropriate size, knife-coating or bar-coating may be used to ensure uniform coating of the substrate.

The moisture content of the organic coating composition is preferably less than 1000, 500, 250, 100, 50 ppm. In some embodiments, the coating composition is applied to the substrate at a low relative humidity, e.g. of less than 40%, 30% or 20% at 25° C.

The coating compositions can be applied in an amount sufficient to achieve the desired repellency properties. Coatings as thin as 250, 300, 350, 400, 450, or 500 nm ranging up to 1, 1.5, 2, 2.5, 3, 3.5, 4, 4.5, or 5 microns can provide the desired repellency. However, thicker coatings (e.g., up to about 10, 15, 20 microns or more) can also be used. Thicker coatings can be obtained by applying to the substrate a single thicker layer of a coating composition that contains a relatively high solids concentration. Thicker coatings can also be obtained by applying successive layers to the substrate.

In another embodiment, the fluorochemical material can be combined with a thermally processible (e.g. thermoplastic) polymer and then melt processed into an article, substrate thereof, or surface layer thereof. In this embodiment, the fluorochemical material typically migrates to the surface forming a surface layer with a high concentration of fluorochemical material relative to the total amount of fluorochemical material and thermally processible polymer.

In typical embodiments, the amount of fluorochemical material melt additive is at least about 0.05, 0.1, 0.25, 0.5, 1.5, 2.0 or 2.5 wt.-% and in some embodiments, at least about 3.0, 3.5, 4.0, 4.5 or 5 wt.-%. The amount of fluorochemical material is typically no greater than 25, 20, 15, or 10 wt.-% of the sum of the fluorochemical material melt additive and thermally processible polymer.

To form a polymer blend by melt processing, the fluorochemical material can be, for example, mixed with pelletized, granular, powdered or other forms of the thermally processible polymer and then melt processed by known methods such as, for example, molding or melt extrusion. The fluorochemical material can be mixed directly with the polymer or it can be mixed with the polymer in the form of a “master batch” (concentrate) of the fluorochemical material in the polymer. If desired, an organic solution of the fluorochemical material can be mixed with powdered or pelletized polymer, followed by drying (to remove solvent) and then melt processing. Alternatively, the fluorochemical composition can be added to the polymer melt to form a mixture or injected into a molten polymer stream to form a blend immediately prior to extrusion or molding into articles.

In some embodiments, the melt processible (e.g. thermoplastic) polymer is a polyolefin, polyester, polyamide, polyurethane, or polyacrylate.

The fluorochemical melt additives are generally a solid at room temperature (e.g. 25° C.) and at the use temperatureas previosly descirbed. The fluorochemical material and thermally processible polymer are selected such that the fluorochemical material and/or siloxane material is typically molten at the melt processing temperature of the mixture. In some embodiments, the fluorochemical material has a melt temperature no greater than 200, 190, 180, 170, or 160° C.

Extrusion can be used to form polymeric films. In film applications, a film forming polymer is simultaneously melted and mixed as it is conveyed through the extruder by a rotating screw or screws and then is forced out through a slot or flat die, for example, where the film is quenched by a variety of techniques known to those skilled in the art. The films optionally are oriented prior to quenching by drawing or stretching the film at elevated temperatures. Adhesive can optionally be coated or laminated onto one side of the extruded film in order to apply and adhere the (liquid, ice) repellent film onto a substrate.

Molded articles are produced by pressing or by injecting molten polymer from a melt extruder as described above into a mold where the polymer solidifies. Typical melt forming techniques include injection molding, blow molding, compression molding and extrusion, and are well known to those skilled in the art. The molded article is then ejected from the mold and optionally heat-treated to effect migration of the polymer additives to the surface of the article.

After melt processing, an annealing step can be carried out to enhance the development of repellent characteristics. The annealing step typically is conducted below or above the melt temperature of the polymer for a sufficient period of time. The annealing step can be optional.

The (e.g. liquid, ice) repellent coating composition can be provided on a wide variety of organic or inorganic substrates.

Suitable polymeric materials for substrates include, but are not limited to, polyesters (e.g., polyethylene terephthalate or polybutylene terephthalate), polycarbonates, acrylonitrile butadiene styrene (ABS) copolymers, poly(meth)acrylates (e.g., polymethylmethacrylate, or copolymers of various (meth)acrylates), polystyrenes, polysulfones, polyether sulfones, epoxy polymers (e.g., homopolymers or epoxy addition polymers with polydiamines or polydithiols), polyolefins (e.g., polyethylene and copolymers thereof or polypropylene and copolymers thereof), polyvinyl chlorides, polyurethanes, fluorinated polymers, cellulosic materials, derivatives thereof, and the like. In some embodiments, where increased transmissivity is desired, the polymeric substrate can be transparent. The term “transparent” means transmitting at least 85 percent, at least 90 percent, or at least 95 percent of incident light in the visible spectrum (wavelengths in the range of 400 to 700 nanometers). Transparent substrates may be colored or colorless.

Suitable inorganic substrates include metals and siliceous materials such as glass. Suitable metals include pure metals, metal alloys, metal oxides, and other metal compounds. Examples of metals include, but are not limited to, chromium, iron, aluminum, silver, gold, copper, nickel, zinc, cobalt, tin, steel (e.g., stainless steel or carbon steel), brass, oxides thereof, alloys thereof, and mixtures thereof.

The coating composition can be used to impart or enhance (e.g. ice, aqueous liquid and/or oil) repellency of a variety of substrates and articles. The term “ice” includes any form of frozen water as previously described.

The term “aqueous” means a liquid medium that contains at least 50, 55, 60, 65, or 70 wt-% of water. The liquid medium may contain a higher amount of water such as at least 75, 80, 85, 90, 95, 96, 97, 98, 99, or 100 wt-% water. The liquid medium may comprise a mixture of water and one or more water-soluble organic cosolvent(s), in amounts such that the aqueous liquid medium forms a single phase. Examples of water-soluble organic cosolvents include for example methanol, ethanol, isopropanol, 2-methoxyethanol, (2-methoxymethylethoxy)propanol, 3-methoxypropanol, 1-methoxy-2-propanol, 2-butoxyethanol, ethylene glycol, ethylene glycol mono-2-ethylhexylether, tetrahydrofuran, 2,2,4-trimethyl-1,3-pentanediol monoisobutyrate, tetraethylene glycol di(2-ethylhexoate), 2-ethylhexylbenzoate, and ketone or ester solvents. The amount of organic cosolvent does not exceed 50 wt-% of the total liquids of the coating composition. In some embodiments, the amount of organic cosolvent does not exceed 45, 40, 35, 30, 25, 20, 15, 10 or 5 wt-% organic cosolvent. Thus, the term aqueous includes (e.g. distilled) water as well as water-based solutions and dispersions such as paint.

Objects and advantages of this invention are further illustrated by the following examples, but the particular materials and amounts thereof recited in these examples, as well as other conditions and details, should not be construed to unduly limit this invention. These examples are for illustrative purposes only and are not meant to be limiting on the scope of the appended claims.

| Material | | |
|---|---|---|
| designation | Description | Obtained from |
| MEK | Methyl ethyl ketone | Avantor |
| | | Performance |
| | | Materials, |
| | | Center Valley, PA |
| Cyclohexanone | Cyclohexanone | Avantor |
| | | Performance |
| | | Materials, |
| | | Center Valley, PA |
| Acetone | Acetone | VWR |
| | | International, |
| | | Radnor, PA |
| MDI | Methylene diphenyldiisocyanate | Bayer, Germany |
| DMF | Dimethylformamide | VWR |
| | | International, |
| | | Radnor, PA |
| Capa 2100 | Linear polyester diol under trade | Perstorp Holding |
| | designation “CAPA 2100” | AB, Malmo, |
| | | Sweden |
| 1,4-butane diol | 1,4-butane diol | Sigma-Aldrich |
| | | Chemical |
| | | Company, |
| | | St. Louis, MO |
| ODDA | Octadecanedioic acid | Cognis |
| | | Corporation, |
| | | Cinncinnati, Ohio |
| Polystyrene | Atactic polystyrene beads with | Alfa Aesar, |
| | formula weights of 800-5000 g/mol | Ward Hill, MA |
| | (PS₅) or 125-250 kg/mol (PS₂₅₀), | |
| TPU2 | Polyurethane resin, under trade | Lubrizol Advanced |
| | designation “ESTANE 5703” | Materials, Inc., |
| | | Cleveland, OH |
| Unicid 350 | Long chain, linear primary carboxylic | Baker Hughes Inc., |
| | acid, under trade designation | Houston, TX |
| | “UNICID 350” | |
| Krystalgran ® | aliphatic polyester based | Huntsman, |
| PN3429-108 | thermoplastic | Auburn Hills, MI |
| polyurethane | polyurethane | |

### Synthesis of Fluorochemical Material 1 (FC-1)

MEFBSE (C₄F₉SO₂N(CH₃)C₂H₄OH), a fluorochemical alcohol having an equivalent weight of 357, was made in two stages by reacting perfluorobutanesulfonyl fluoride (PBSF) with methylamine to form MEFBSA (C₄F₉SO₂N(CH₃)H), followed by reaction with ethylenechlorohydrin, using a procedure essentially s described in Example 1 of U.S. Pat. No. 2,803,656 (Ahtbrecht, et al.).

Fluorochemical 1 was then prepared using the protocol described in U.S. Pat. No. 7,396,866 (Jariwala et al.) by esterifying the MEFBSE with octadecanedioic acid at a molar ratio of 2:1 as follows: to a three-necked round bottom flask was added 25 g (0.0793 moles) of Emerox 118 (available from Cognis Corporation, Cincinnati, Ohio), 56.7 g (0.159 moles) of MEFBSE, 100 g toluene and 1 g (0.007 moles) of 70 wt % solution of methanesulfonic acid. The contents of the flask were refluxed using a Dean-Stark trap and a condenser at 112° C. for 12 h. The solution was then cooled to 80° C. To this solution was added 1.08 g (0.007 moles) of triethanol amine and the solution was stirred at 80° C. for 1 h. This toluene solution was then washed with 75 g hot water (80° C.) three times. After the last wash the organic bottom layer was distilled to remove the toluene. The residue remaining the flask was the diester product, which was poured into a jar and allowed to crystallize on cooling to room temperature.

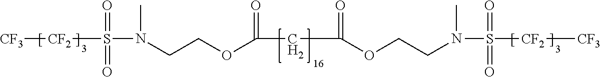

### Synthesis of Fluorochemical Material 2 (FC-2)

Fluorochemical 2 was made by the esterification of a long chain hydrocarbon acid (Unicid 350, C25 average), and MEFBSE (C₄F₉SO₂N(CH₃)C₂H₄OH) in the same manner as the synthesis of Fluorochemical 1.

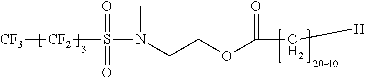

### Synthesis of Fluorochemical Polyester Additive (FC-3)

MeFBSE—C₄F₉SO₂N(CH₃)C₂H₄OH was prepared in the same manner as previously described.

FBSEE—C₄F₉SO₂N(C₂H₄OH)₂ can be prepared as described in Example 8 of U.S. Pat. No. 3,787,351 (Olson), except that an equimolar amount of C₄F₉SO₂NH₂ is substituted for C₈F₁₇SO₂NH₂; C₄F₉SO₂NH₂ can be prepared by reacting perfluorobutane sulfonyl fluoride (PBSF) with an equimolar amount of NH₃.

To a round-bottomed reaction flask equipped with a stirrer, heater and a Dean-Stark trap was added octadecanedioic acid (ODDA, 30 g, 0.095 moles), FBSEE (27.5 g, 0.071 moles), MeFBSE (17.01 g, 0.048 moles), toluene (100 g) and methanesulfonic acid (1 g). The resulting mixture was allowed to reflux for 15 hours at 115° C. When the desired amount of water (3 g) was collected, the temperature was reduced to 80° C. Then K₂CO₃ (2 to 3 g) was added and the mixture was stirred for an additional 30 minutes. FTIR analysis showed the absence of any hydroxyl peak. The mixture was hot filtered and the solvent was removed by rotary evaporation. The molecular weight was measured using GPC and polystyrene standards and was determined to be Mn ˜2800 g/mole and Mw ˜5400 g/mole.

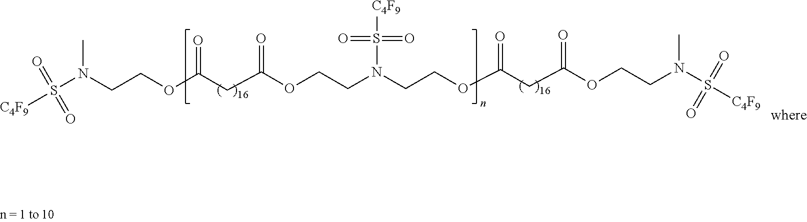

### Synthesis of Polyurethane TPU1

100 g Capa 2100 was mixed with 50.02 g MDI in a 500 mL round-bottomed flask and heated up to 70° C. for 2 h. Next, 200 g of DMF and 8.11 g of 1,4-butane diol were added. The reactants were heated for an additional 3 h to obtain the thermoplastic urethane polymer. The polymer mixture is approximately 44% solids in DMF. Prior to coating, the mixture was diluted to 20% solids with DMF, then further diluted to either 4 or 5% solids with MEK, as noted in the Tables, below.

### Methods

### Method for Contact Angle Measurements

Water and hexadecane contact angles were measured using a Ramé-Hart goniometer (Ramé-Hart Instrument Co., Succasunna, N.J.). Advancing (θ_{adv}) and receding (θ_{rec}) angles were measured as the test liquid (e.g. water or hexadecane) was supplied via a syringe into or out of sessile droplets (drop volume ˜5 μL). Measurements were taken at 2 different spots on each surface, and the reported measurements are the averages of the four values for each sample (a left-side and right-side measurement for each drop).

### Centrifugal Testing at AMIL:

All AMIL samples were dip coated from the coatings solutions directly onto aluminum bars received from AMIL as described below.

Ice was deposited simultaneously on three test films and three bare aluminum controls at the AMIL facility by exposing them to an impinging spray of supercooled water at −10° C. These conditions yielded approximately 5 mm thick heavy rime ice with a density of 0.88 g/cm³. Following icing, the beams are balanced and placed into a centrifuge specially adapted to measure ice adhesion. All measurements are performed at −10° C. The rotational speed of the beam is progressively increased until the centrifugal force detaches the ice. The detachment of the ice is picked up by piezoelectric cells that are sensitive to vibrations and the rotational speed at detachment is recorded by the computer. The specific ice adhesion strength is calculated using the speed of detachment, the mass of the ice, and the beam length. AMIL commonly reports the results as adhesion reduction factors (ARFs) that are defined as

$$A R F = \frac{Mean ice adhesion on bare aluminum}{Mean ice adhesion on candidate coating}$$

### Ice Adhesion Cuvette Method:

A hole is punched into the side wall near the bottom of a cuvette(having a 1 cm×1 cm cross-section and a height of 4.5 cm). The cuvette is inverted such that its opening is placed in contact with the test surface, and a rubber band is wrapped around the cuvette to ensure constant contact with the substrate. This setup is placed in an environmental chamber at −20° C. for ˜30 min, and 1 mL of water at 0° C. is injected through the hole into the cuvette. The water comes into contact with the test substrate and a column of ice encased in the cuvette forms when the sample is held at −20° C. for 15-20 hours. The rubber band is carefully removed and the iced sample is mounted onto the Iₘₐₓ test apparatus. The force required to detach the ice columns from the test substrates was measured by propelling the force probe into the side of the column at a velocity of 2.6″/minute. The probe was located ˜1 mm above the substrate to minimize torque on the ice columns.

### Water Soak Repellency Durability Test:

The coated aluminum samples were soaked (fully submerged) overnight in deionized water in a sealed glass jar. After 24 hours, the samples were removed from the water and allowed to air dry overnight at room temperature. The contact angles were then remeasured.

### Preparative Examples PE1-PE8: Solutions of Polymers and Fluorochemical Additives Used to Coat Substrates

Various coating solution were made by combining the fluorochemical additive, organic polymeric binder (when present) with organic solvent(s) while stirring and heating to 60° C. to dissolve the materials. The components of the coating solution are described in the following table.

| Preparative | | Wt % | |
|---|---|---|---|
| Example | Coating Formulation | Solids | Solvent |
| PE1 | C18 Polyester (FC-3) | 9.6 | MEK |
| PE2—Control | 100 TPU1 | 5.6 | MEK |
| PE3 | 95/5 TPU1/FC-3 | 5 | 60:40 |
| | | | MEK:Cyclohexanone |
| PE4—Control | 100 TPU2 | 5 | MEK |
| PE5 | 95/5 TPU2/FC-3 | 5 | 60:40 |
| | | | MEK:Cyclohexanone |
| PE6 | 94/3/3 TPU2/FC-3/FC-1 | 10 | MEK |
| PE7—Control | 100 Polystyrene | 5 | MEK |
| PE8 | 95/5 Polystyrene/FC-3 | 5 | MEK |

### Dip Coating Protocol for Solution Coating of Aluminum Coupons

The 1″×4″ aluminum coupons were removed from their package, rinsed with isopropanol, and wiped dry with a WYPALL paper towel. The aluminum coupons were dip coated at a controlled speed by lowering the coupons into coating solutions, leaving a small top portion of the substrate uncoated to clamp and hold the sample. Upon maximum immersion depth of the substrate, the coupon was raised up and out of the solution at controlled speed using a standard dip-coating procedure with a KSV dip-coater. The coated samples were dried at room temperature for a few minutes and then heated at 110° C. for 15 minutes. Larger aluminum pieces were dip coated similarly for AMIL testing.

### EXAMPLES

Solutions of coating formulations PE1-PE8 were dip-coated onto aluminum coupons and the solvent was allowed to evaporate under ambient conditions for a few minutes, followed by heating in a 110° C. oven for fifteen minutes. Water and hexadecane contact angles were then measured on the coated aluminum. The results are summarized in the following table:

Advancing and receding water contact angles

| | | | | | CAH = |
|---|---|---|---|---|---|
| | | | | | θ_{adv} − |
| Example | Coating | Description of Coating | θ_{adv} | θ_{rec} | θ_{rec} |
| EX1 | PE1 | C18 Polyester (FC-3) | 119 | 101 | 18 |
| CE2—Control | PE2 | 100 TPU1 | 92 | 49 | 43 |
| EX3 | PE3 | 95/5 TPU1/FC-3 | 120 | 105 | 15 |
| CE4—Control | PE4 | 100 TPU2 | 76 | <20 | >56 |
| EX5 | PE5 | 95/5 TPU2/FC-3 | 118 | 104 | 14 |
| EX6 | PE6 | 94/3/3 TPU2/FC-3/FC-1 | 120 | 106 | 14 |
| CE7—Control | PE7 | 100 Polystyrene | 91 | 80 | 11 |
| EX8 | PE8 | 95/5 Polystyrene/FC-3 | 118 | 112 | 6 |

Advancing and receding hexadecane contact angles

| | | | | | CAH = θ_{adv} − |
|---|---|---|---|---|---|
| Example | Coating | Description of Coating | θ_{adv} | θ_{rec} | θ_{rec} |
| EX1 | PE1 | C18 Polyester (FC-3) | 79 | 67 | 12 |
| CE2 | PE2 | 100 TPU1 | <20 | <20 | NA |
| EX3 | PE3 | 95/5 TPU1/FC-3 | 74 | 72 | 2 |
| CE4 | PE4 | 100 TPU2 | 27 | <20 | NA |
| EX5 | PE5 | 95/5 TPU2/FC-3 | 77 | 69 | 8 |
| EX6 | PE6 | 94/3/3 TPU2/FC-3/FC-1 | 76 | 73 | 3 |
| CE7 | PE7 | 100 Polystyrene | <20 | <20 | NA |
| EX8 | PE8 | 95/5 Polystyrene/FC-3 | 77 | 71 | 6 |

All of the coatings provided higher receding contact angles and lower CAH than the control polymer binder coatings. Furthermore, the inclusion of the organic polymer binder improves the durability.

### Preparative Examples PE9-PE10: Melt Processed Polymers and Fluorochemical Additives

The melt blends were mixed using a C.W. Brabender® Instruments Brabender® Bowl Mixer Drive Unit. The mixer was heated to 180° C. The Krystalgran® base resin was weighed and put into the mixer. FC-3 was then added into the mixer and mixed with the base resin. 50 grams of solids were initially added to the mixer in the specified weight ratios. If the mixer bowl was not full, material would be added in 5 gram increments until the bowl was full enough to mix properly. Once all of the material was in the mixer, it was left to mix for approximately 5 minutes or until all of the additive had been thoroughly mixed with the polymeric binder.

A Carver 4-post manual Hydraulic press was used to flatten the blends out into films. The press was heated to 300° F. The blends were placed between 2 sheets of Teflon which were placed between two silicone pads. Force was applied until the material reached a desired thickness. Thickness depended on which characterization the film was to be used for. Extruded films were used for certain characterizations as well. 15-16 grams of pressed film were taken and cut into small pieces. The small pieces could then be fed into a DSM Micro Compounder for extrusion. The extruder was heated to 180° C., and the screws were set to 75-100 rpm. A 0.6 mm die was used. A batch of the pure base resin was used to purge the machine between batches containing additives.

The thermally processed films that were prepared were as follows:

| Preparative | | Wt % FC |
|---|---|---|
| Example | Melt Pressed Film Formulation | Additive |
| CE9—Control | Krystalgran ® PN3429-108 | 0 |
| EX10—PE10 | 96/4 Krystalgran ® PN3429-108/FC-3 | 4 |

Water contact angles were measured on the thermally processed films. These results were as follows:

| | | | | | CAH = θ_{adv} − |
|---|---|---|---|---|---|
| Example | Film | Description of Film or Coating | θ_{adv} | θ_{rec} | θ_{rec} |
| CE9 | PE9 | Krystalgran ® PN3429-108 | 95 | 65 | 30 |
| EX10 | PE10 | 96/4 Krystalgran ® | 115 | 91 | 24 |
| | | PN3429-108/FC-3 | | | |

Some of the samples were subjected to the Water Soak Repellency Durability Test and the contact angles remeasured as previously described. The results are as follows:

Advancing and receding water contact angles after water soaking

| | | Water θ_{adv} | | Water θ_{rec} | |
|---|---|---|---|---|---|
| Coating | Coating Description | Initial | After Soak | Initial | After Soak |
| CE4 | 100 TPU2 | 76 | 77 | <20 | <20 |
| EX5 | 95/5 TPU2/FC-3 | 118 | 115 | 104 | 82 |
| EX6 | 94/3/3 TPU2/FC-3/FC-1 | 120 | 111 | 106 | 79 |

Advancing and receding hexadecane contact angles after water soaking

| | | Hexadecane θ_{adv} | | Hexadecane θ_{rec} | |
|---|---|---|---|---|---|
| | | | After DI | | |
| | | | Water | | After DI |
| Coating | Coating Description | Initial | Soak | Initial | Water Soak |
| CE4 | 100 TPU2 | 27 | <20 | <20 | <20 |
| EX3 | 95/5 TPU2/FC-3 | 77 | 73 | 69 | 49 |
| EX6 | 94/3/3 TPU2/FC-3/FC-1 | 76 | 77 | 73 | 51 |

EX11-12-PE5 coating solution was applied to PET film (3M Company) by means of a #13 Mayer rod (RD Specialties). The coated PET film was dried at either 21° C. for at least 30 minutes (EX11) or at 110° C. for 10 minutes (EX11).

The contact angles of EX11-12 were determined in the same manner as previously described. The results were as follows:

| | | | | 10% (by wt.) aqueous | | |
|---|---|---|---|---|---|---|
| | | | | 2-n-butoxyethanol | | |
| | Water Contact Angles | | | Contact Angles | | |
| | | | CAH | | | CAH |
| Example | θ_{adv} | θ_{rec} | (θ_{adv} − θ_{rec}) | θ_{adv} | θ_{rec} | (θ_{adv} − θ_{rec}) |
| EX11 | 120 | 99 | 21 | 77 | 55 | 22 |
| EX12 | 119 | 102 | 17 | 78 | 56 | 22 |

### Surface Abrasion Test

A sample of sufficient size (e.g., 6 cm by 2 cm) was prepared and mounted on a Taber Abraser (Taber Industries 5750 Linear Abraser). A crockmeter square (AATC Crockmeter Square from Testfabrics, Inc.) was attached to the abraser head by means of a rubber band. No additional weights were placed on top of the abraser head. The cycle speed was set to 15 cycles/min, and each substrate was subjected to 2 abrasion cycles (or in otherwords the abraser head passed back and forth twice).

| | | | | 10% (by wt.) aqueous | | |
|---|---|---|---|---|---|---|
| | | | | 2-n-butoxyethanol | | |
| | Water Contact Angles | | | Contact Angles | | |
| | After Abrasion | | | After Abrasion | | |
| | | | CAH | | | CAH |
| Example | θ_{adv} | θ_{rec} | (θ_{adv} − θ_{rec}) | θ_{adv} | θ_{rec} | (θ_{adv} − θ_{rec}) |
| EX11 | 119 | 85 | 34 | 77 | 50 | 27 |
| EX12 | 120 | 90 | 30 | 77 | 56 | 21 |

All the examples just described are believed to reduce the force required to remove ice from the repellent surface, and may delay the formation of ice on the surface of the treated substrates under icing conditions. However, due to the cost, all of such examples were not subject to testing at the Anti-icing Materials International Laboratory (AMIL, Chicoutimi, Quebec, Canada).

### Ice Adhesion Test Results by Cuvette Method and as Measured at AMIL.

| | | | | Ice | |
|---|---|---|---|---|---|
| | | Ice | | Adhesion | Std. |
| | | Adhesion | Std. | kPa | Dev. |
| | | kPA | Deviation | Cuvette | Cuvette |
| Example | Sample | AMIL | AMIL | Method | Method |
| PE2 | 100 TPU1 | 342 | 23 | 368 | 58 |
| | (CE-18) | | *1.8 | | |
| PE3 | 95/5 TPU1/ | 143 | 24 | 174 | 37 |
| | FC-3 | | *4.0 | | |
| PE4— | 100 TPU2 | NA | NA | 382 | 51 |
| Control | (CE-19) | | | | |
| PE5 | 95/5 TPU2/FC- | 114 | 14 | 189 | 34 |
| | | | *5.3 | | |
| PE6 | 94/3/3 TPU2/ | NA | NA | 186 | 15 |
| | FC-3/FC-1/ | | | | |
| | FC-2 | | | | |
| PE9— | Krystalgran | NA | NA | 355 | 17 |
| Control | PN3429-108 | | | | |
| PE10 | 96/4 Krystalgran | NA | NA | 239 | 10 |
| | PN3429-108/ | | | | |
| | FC-3 | | | | |

*Ice Adhesion Factor, as reported by AMIL.

1. An article subject to ice formation during normal use comprising a repellent surface such that the receding contact angle of the surface with water ranges from 90 degrees to 135 degrees wherein the repellent surface comprises a fluorochemical material having a Mn of at least 1500 g/mole.

2. The article of claim 1 wherein the fluorochemical material has a molecular weight of no greater than 50,000 g/mole.

3. The article of claim 1 wherein the fluorochemical material has a melt temperature of no greater than 200° C.

4. The article of claim 1 wherein the repellent surface further comprises a non-fluorinated organic polymeric binder.

5. The article of claim 1 wherein the repellent surface comprises a fluorochemical material comprising terminal fluorinated groups, pendent fluorinated groups, and at least one hydrocarbon groups averaging at least 8 carbon atoms.

6. (canceled)

7. The article of claim 1 wherein the fluorochemical material comprises a material of the formulas:
R_{f}QO—[C(O)R¹C(O)OR²O]ₘ[C(O)R¹C(O)]m-OQRf a)
R_{f}QC(O)—[OR²OC(O)R¹C(O)]ₙ[OR²O]ₘ—(O)CQR_{f} b)
R_{f}QO—C(O)NHR¹NHC(O)—OQRf c)
R_{f}QO—[C(O)NHR¹NHC(O)OR²O]ₙ[C(O)NHR¹NHC(O)]m-OQRf; d)
or mixtures thereof;
wherein
n is selected from 1, 2, 3, 4, 5, 6, 7, 8, 9, or 10;
m is 1;
R_{f} is a fluorinated group;
Q is a divalent linking group;
R¹ is a hydrocarbon moiety; and
R² is a divalent organic group having a pendent fluorinated group, Rf.

8. The article of claim 7 wherein R¹ comprises a hydrocarbon group averaging at least 8 carbon atoms.

9. The article of claim 7 wherein Q is the group —SO₂N(CH₃)(CH₂)ₙ— wherein n ranges from 1-4.

10. The article of claim 7 wherein R_{f} is CF₃[CF₂]₃— for at least 50 wt.-% of the fluorochemical material.

11. (canceled)

12. The article of claim 7 wherein the fluorochemical material has a fluorine content of at least 25 wt-%.

13. The article of claim 1 wherein the repellent surface further comprises at least one compound of the formula:
(R_{f}-L-P)ₙA
R_{f} is a fluorinated group;
L is independently an organic divalent linking group;
P is a catenary, divalent heteroatom-containing carbonyl moiety, such as —C(O)O—;
A is hydrocarbon moiety;
and n typically ranges from 1 to 3.

14. The article of claim 4 wherein the non-fluorinated polymeric binder is selected from polystyrene, acrylic, polyester, polyurethane, polyolefin, and polyvinyl chloride.

15. The article of claim 1 wherein the repellent surface exhibits one or more properties selected from
i) a difference between an advancing contact angle and the receding contact angle with water of less than 15 degrees;
ii) a receding contact angle with water of at least 90 degrees after soaking in water for 24 hours;
iii) a receding contact angle with hexadecane of at least 50 degrees; and
iv) a receding contact angle with hexadecane of at least 45 degrees after soaking in water for 24 hours.

16-18. (canceled)

19. The article of claim 1 wherein the fluorochemical material is not a fluoroalkyl silsesquioxane.

20. (canceled)

21. The article of claim 1 wherein the article comprises the repellent surface disposed on a substrate.

22. (canceled)

23. The article of claim 21 wherein the substrate is a metal substrate.

24. The article of claim 1 wherein the article is a heat exchanger.

25. The article of claim 1 wherein the repellent surface reduces the force of ice adhesion in comparison to the same article without the repellent surface.

26. A method of making an article comprising;
providing an article subject to ice formation during normal use;
providing a liquid repellent surface according to claim 1 on the article.

27-28. (canceled)

29. The article of claim 1 wherein the repellent surface or coating is free of fluoroalkyl groups with 8 or more carbon atoms.
